(19) United States
(12) Patent Application Publication
(10) Pub. No.: US 2026/0269456 A1
(43) Pub. Date: Sep. 10, 2026

(54) ANTENNA MODULE AND METHOD FOR MANUFACTURING THE SAME

(71) Applicant: Murata Manufacturing Co., Ltd., Nagaokakyo-shi (JP)

(72) Inventors: Michiharu YOKOYAMA, Nagaokakyo-shi (JP); Hiroki YOSHIMORI, Nagaokakyo-shi (JP); Atsushi KASUYA, Nagaokakyo-shi (JP); Yukiya HIRAOKA, Nagaokakyo-shi (JP); Keisei TAKAYAMA, Nagaokakyo-shi (JP); Hideki UEDA, Nagaokakyo-shi (JP)

(73) Assignee: Murata Manufacturing Co., Ltd., Nagaokakyo-shi (JP)

(21) Appl. No.: 19/672,795

(22) Filed: May 11, 2026

Related U.S. Application Data
(63) Continuation-in-part of application No. PCT/JP2024/042034, filed on Nov. 27, 2024.

(30) Foreign Application Priority Data
Nov. 27, 2023 (JP) 2023-200220

(51) Int. Cl. H01Q 1/22; H01Q 21/00

(52) U.S. Cl. CPC H01Q 1/2283; H01Q 1/2208; H01Q 21/0087

(57) ABSTRACT

An antenna module includes an antenna substrate, at least one radiation electrode on the antenna substrate, and a radio-frequency circuit module on the antenna substrate, wherein the radio-frequency circuit module has a rectangular shape with first through fourth module side surfaces, the first and second module side surfaces corresponding to the two long sides of the rectangular shape, and wherein the antenna substrate has first through fourth substrate side surfaces, the first substrate side surface being coplanar with or located inward from the first module side surface in plan view, and at least one of the second through fourth substrate side surfaces being in a region that does not overlap the radio-frequency circuit module in plan view.

### CROSS-REFERENCE TO RELATED APPLICATIONS

This application is a continuation-in-part of PCT Application No. PCT/JP2024/042034, filed on Nov. 27, 2024, which claims priority to Japanese Patent Application No. 2023-200220, filed on Nov. 27, 2023. The entire contents of each of the above-listed applications are incorporated herein by reference.

### TECHNICAL FIELD

The present disclosure relates to an antenna module and a method for manufacturing the antenna module.

### BACKGROUND ART

Patent Documents 1 and 2 describe an antenna module (referred to as an electronic element module in Patent Document 1 and as an electronic device package in Patent Document 2) including an antenna substrate, a plurality of electronic components mounted on the antenna substrate, and a resin molded portion that covers the electronic components. Patent Document 3 describes an antenna module (referred to as a receiver in Patent Document 3) in which an antenna substrate is laminated on a drive circuit board. Patent Document 4 describes an antenna module (referred to as a wireless module in Patent Document 4) in which an antenna package and a semiconductor package are laminated together.

### CITATION LIST

### Patent Document

Patent Document 1: Japanese Unexamined Patent Application Publication No. 2020-174172
Patent Document 2: U.S. Patent Application Publication No. 2022/0037271
Patent Document 3: Japanese Unexamined Patent Application Publication No. 2020-36311
Patent Document 4: U.S. Patent Application Publication No. 2019/0035749

### SUMMARY

An antenna module according to an aspect of embodiments includes an antenna substrate, at least one radiation electrode on the antenna substrate, and a radio-frequency circuit module on the antenna substrate, wherein the radio-frequency circuit module has a rectangular shape with two long sides and two short sides in a plan view, the rectangular shape having a first side surface, a second side surface, a third side surface, and a fourth side surface, the first side surface and the second side surface corresponding to the two long sides, and the third side surface and the fourth side surface corresponding to the two short sides, wherein the antenna substrate has a first substrate side surface, a second substrate side surface opposite to the first substrate side surface, a third substrate side surface, and a fourth substrate side surface, the third substrate side surface and the fourth substrate side surface being disposed between the first substrate side surface and the second substrate side surface, wherein, in the plan view, the first substrate side surface of the antenna substrate is coplanar with the first side surface of the radio-frequency circuit module or overlaps the radio-frequency circuit module to be located inward from the first side surface, and wherein, in the plan view, at least one of the second substrate side surface, the third substrate side surface, and the fourth substrate side surface of the antenna substrate is in a region that does not overlap the radio-frequency circuit module.

### BRIEF DESCRIPTION OF DRAWINGS

FIG. 1 is a perspective view of an antenna module according to a first embodiment.

FIG. 2 is a perspective view of the antenna module according to the first embodiment as viewed from a second principal surface.

FIG. 3 is a plan view of the antenna module according to the first embodiment.

FIG. 4 is a sectional view taken along line IV-IV′ in FIG. 3.

FIG. 5 illustrates a method for manufacturing the antenna module according to the first embodiment.

FIG. 6 is a plan view of an antenna module according to a first modification.

FIG. 7 is a sectional view of an antenna module according to a second modification.

FIG. 8 is a sectional view of an antenna module according to a third modification.

FIG. 9 is a sectional view of an antenna module according to a fourth modification.

FIG. 10 is a plan view of an antenna module according to a second embodiment.

FIG. 11 is a plan view of an antenna module according to a fifth modification.

FIG. 12 is a sectional view of an antenna module according to a third embodiment.

FIG. 13 is a sectional view of an antenna module according to a sixth modification.

FIG. 14 is a sectional view of an antenna module according to a seventh modification.

FIG. 15 is a sectional view of an antenna module according to an eighth modification.

FIG. 16 is a sectional view of an antenna module according to a fourth embodiment.

FIG. 17 is a sectional view of an antenna module according to a fifth embodiment.

FIG. 18 is a sectional view of an antenna module according to a ninth modification.

FIG. 19 is a sectional view of an antenna module according to a tenth modification.

FIG. 20 is a sectional view of an antenna module according to an eleventh modification.

FIG. 21 is a sectional view of an antenna module according to a sixth embodiment.

FIG. 22 is a sectional view of an antenna module according to a twelfth modification.

FIG. 23 is a sectional view of an antenna module according to a seventh embodiment.

FIG. 24 is a sectional view of the antenna module according to the seventh embodiment taken along a Y direction.

FIG. 25 is a sectional view of an antenna module according to a thirteenth modification taken along the Y direction.

FIG. 26 is a sectional view of an antenna module according to a fourteenth modification taken along the Y direction.

FIG. 27 is a sectional view of an antenna module according to a fifteenth modification taken along the Y direction.

FIG. 28 is a sectional view of an antenna module according to a sixteenth modification.

### DESCRIPTION OF EMBODIMENTS

In each of the antenna modules of Patent Documents 1 and 2, the antenna substrate is cut along the outer periphery thereof, thereby defining the outer shape of the antenna module. This may lead to a reduction in the dimensional accuracy of the outer shape due to cutting misalignment. According to Patent Documents 3 and 4, the drive circuit board or the semiconductor package having a greater area (width) than the antenna substrate in plan view is mounted in the antenna module. This makes it difficult to achieve size reduction.

An aspect of the present disclosure is to provide an antenna module having a smaller size and an outer shape with an increased dimensional accuracy and a method for manufacturing the antenna module.

According to the antenna module and the method for manufacturing the antenna module of the present disclosure, the antenna module can have a smaller size and an outer shape with an increased dimensional accuracy.

Embodiments of the present disclosure will now be described in detail with reference to the drawings. These embodiments are not intended to limit the present disclosure. Embodiments described in the present disclosure are examples, and partial substitutions or combinations of configurations in different embodiments are possible. In the modifications and in the second and subsequent embodiments, descriptions of matters common to the first embodiment are omitted, and only differences will be described. In particular, similar effects of similar configurations will not be described for each embodiment.

### First Embodiment

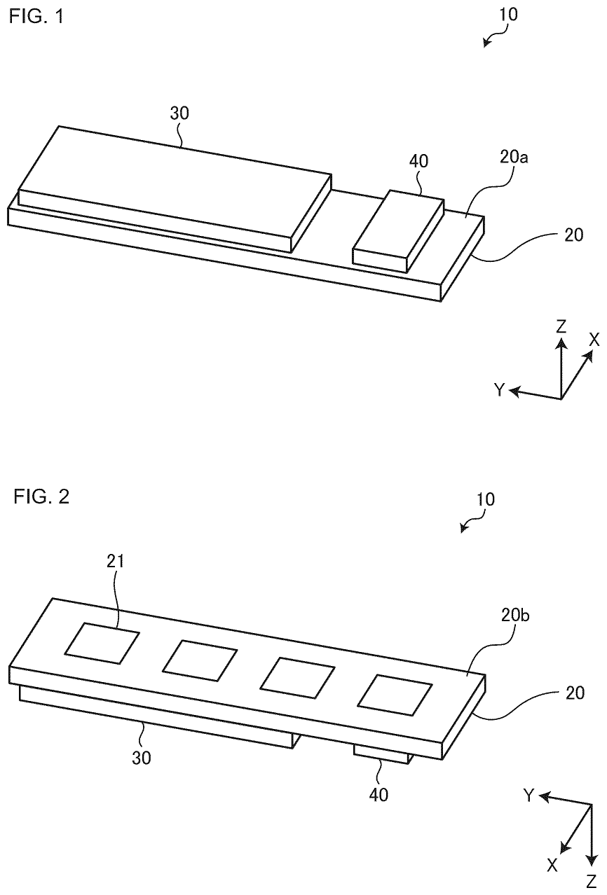

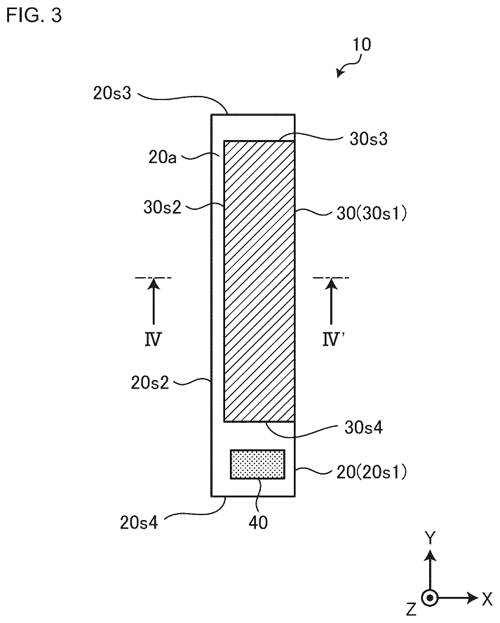

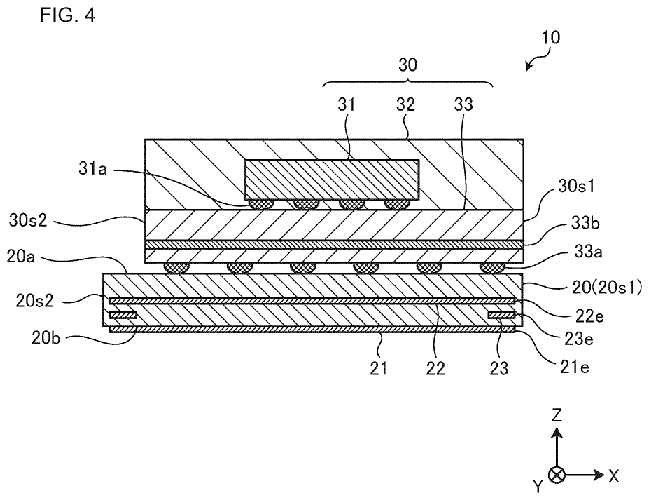

FIG. 1 is a perspective view of an antenna module according to a first embodiment, as viewed from a first principal surface. FIG. 2 is a perspective view of the antenna module according to the first embodiment, as viewed from a second principal surface. FIG. 3 is a plan view of the antenna module according to the first embodiment, as viewed from the first principal surface. FIG. 4 is a sectional view taken along line IV-IV′ in FIG. 3.

As illustrated in FIGS. 1 to 4, an antenna module 10 includes an antenna substrate 20, a radio-frequency circuit module 30, and a connector 40. The antenna module 10 is mounted in, for example, a mobile terminal, such as a mobile phone, a smartphone, or a tablet terminal, or an electronic device, such as a personal computer, having a communication function. The antenna module 10 is compatible with, for example, a 4G (fourth generation mobile communication) standard or a 5G (fifth generation mobile communication) standard. The antenna module 10 is not limited to this, and may be compatible with other communication standards.

In the following description, a direction perpendicular to a first principal surface 20a of the antenna substrate 20 is referred to as a Z direction, a direction orthogonal to the Z direction is referred to as an X direction, and a direction orthogonal to the Z direction and the X direction is referred to as a Y direction. The X direction and the Y direction are parallel to the first principal surface 20a of the antenna substrate 20. In the following description, the term “plan view” refers to a view showing the positional relationship as viewed in the direction perpendicular to the first principal surface 20a of the antenna substrate 20 (Z direction).

The antenna substrate 20 is a multilayer substrate including a plurality of dielectric layers laminated together, and has a quadrangular shape in plan view. The antenna substrate 20 is flat plate-shaped and has a first principal surface 20a and a second principal surface 20b opposite to the first principal surface 20a.

The material of the dielectric layers of the antenna substrate 20 is, for example, any one or more of low temperature co-fired ceramics (LTCC), glass epoxy resin, liquid crystal polymer (LCP), fluorocarbon resin, and polyimide resin. Among these materials, LTCC has the highest permittivity, and the permittivity decreases in the order of glass epoxy resin, liquid crystal polymer, and fluorocarbon resin. The antenna substrate 20 may be a rigid substrate or a flexible substrate having flexibility.

As illustrated in FIG. 4, the antenna substrate 20 is provided with radiation electrodes 21, a ground electrode 22, and wiring lines 23. The ground electrode 22 and the wiring lines 23 are provided on inner layers of the antenna substrate 20 (e.g., between the first and second principal surfaces 20a and 20b). As illustrated in FIG. 2, the radiation electrodes 21 are provided on the second principal surface 20b of the antenna substrate 20, and are arranged (e.g., spaced apart from each other) in the Y direction. The radiation electrodes 21 constitute an array antenna. The radiation electrodes 21 each have a quadrangular shape.

The electrodes (the radiation electrodes 21, the ground electrode 22, and the wiring lines 23) provided on the surface layer and the inner layers of the antenna substrate 20 are located inward from substrate side surfaces (first substrate side surface 20s1 and second substrate side surface 20s2) of the antenna substrate 20 (e.g., spaced apart from the substrate side surfaces toward a center of the antenna substrate 20). In other words, end surfaces 21e of the radiation electrodes 21, end surfaces 22e of the ground electrode 22, and end surfaces 23e of the wiring lines 23 are covered by the dielectric layers of the antenna substrate 20. This reduces oxidation of at least the ground electrode 22 and the wiring lines 23 and enhances the interlayer adhesion strength of the antenna substrate 20.

The radiation electrodes 21, the ground electrode 22, and the wiring lines 23 are formed of a conductive metallic material. The radiation electrodes 21, the ground electrode 22, and the wiring lines 23 are made of, for example, a metallic material, such as aluminum (Al), copper (Cu), gold (Au), or silver (Ag), or an alloy containing at least one of these materials.

Each of the radiation electrodes 21 is connected to a radio frequency integrated circuit (RFIC) 31 included in the radio-frequency circuit module 30 through wiring lines and vias provided in or on the inner layers of the antenna substrate 20. Thus, the RFIC 31 supplies radio-frequency signals to feed points of the radiation electrodes 21, and the radiation electrodes 21 radiate radio waves.

As illustrated in FIGS. 1 and 3, the radio-frequency circuit module 30 and the connector 40 are provided on the first principal surface 20a of the antenna substrate 20. The radio-frequency circuit module 30 and the connector 40 are arranged next to each other in the Y direction.

As illustrated in FIG. 4, the radio-frequency circuit module 30 includes the RFIC 31 (radio-frequency circuit), a mold resin 32, and a circuit board 33. The radio-frequency circuit module 30 is a system-in-package (SiP) module. The circuit board 33 is a multilayer substrate including a plurality of dielectric layers laminated together. The dielectric layers of the circuit board 33 may be made of a material that is the same as or different from the above-described material of the antenna substrate 20. The circuit board 33 is mounted on the first principal surface 20a of the antenna substrate 20 with connection terminals 33a (bumps). The circuit board 33 includes a wiring line 33b on an inner layer. The circuit board 33 may also include an additional wiring line on a surface layer.

The RFIC 31 is mounted on the circuit board 33 with connection terminals 31a (bumps). The mold resin 32 is provided on the circuit board 33 and covers the RFIC 31. In FIGS. 1 to 4, the configuration of the radio-frequency circuit module 30 is illustrated schematically. The radio-frequency circuit module 30 may include a radio-frequency circuit that additionally includes an IC, such as a power supply IC 35, other than the RFIC 31 and a plurality of chip components 36 (see FIG. 8), such as a resistor, a capacitor, and an inductor necessary for the operation of the RFIC 31. The radio-frequency circuit module 30 is formed by integrally packaging the circuit board 33, the radio-frequency circuits including the RFIC 31, and the mold resin 32, and is mounted on the antenna substrate 20.

The connector 40 is, for example, a multi-pole connector, and is connected to an external electronic device in which the antenna module 10 is mounted. The connector 40 is not limited to a multi-pole connector, and may be other types of connectors, such as a coaxial connector.

In the present embodiment, similarly to the radio-frequency circuit module 30, the connector 40 is also provided on the first principal surface 20a. Thus, the radio-frequency circuit module 30 and the connector 40 are provided on the side opposite to the second principal surface 20b on which the radiation electrodes 21 are provided, thereby enabling the radiation electrodes 21 to have a sufficient size.

The positional relationship between the antenna substrate 20 and the radio-frequency circuit module 30 will now be described. As illustrated in FIG. 3, the radio-frequency circuit module 30 has a rectangular shape with two long sides and two short sides in plan view. The width of the radio-frequency circuit module 30 in the X direction is less than the length of the radio-frequency circuit module 30 in the Y direction. The radio-frequency circuit module 30 has a first side surface 30s1 and a second side surface 30s2, which correspond to the two long sides, and a third side surface 30s3 and a fourth side surface 30s4, which correspond to the two short sides.

The first side surface 30s1 of the radio-frequency circuit module 30 extends in the Y direction. The second side surface 30s2 extends in the Y direction and is opposite to the first side surface 30s1 in the X direction. The third side surface 30s3 and the fourth side surface 30s4 are disposed between the first side surface 30s1 and the second side surface 30s2. The third side surface 30s3 extends in the X direction. The fourth side surface 30s4 extends in the X direction and is opposite to the third side surface 30s3 in the Y direction.

The antenna substrate 20 has a rectangular shape with two long sides and two short sides in plan view. The width of the antenna substrate 20 in the X direction is less than the length of the antenna substrate 20 in the Y direction. The antenna substrate 20 has a first substrate side surface 20s1 and a second substrate side surface 20s2, which correspond to the two long sides, and a third substrate side surface 20s3 and a fourth substrate side surface 20s4, which correspond to the two short sides.

The first substrate side surface 20s1 of the antenna substrate 20 extends in the Y direction. The second substrate side surface 20s2 extends in the Y direction and is opposite to the first substrate side surface 20s1 in the X direction. The third substrate side surface 20s3 and the fourth substrate side surface 20s4 are disposed between the first substrate side surface 20s1 and the second substrate side surface 20s2. The third substrate side surface 20s3 extends in the X direction. The fourth substrate side surface 20s4 extends in the X direction and is opposite to the third substrate side surface 20s3 in the Y direction.

The first substrate side surface 20s1 and the second substrate side surface 20s2 of the antenna substrate 20 are provided along the two long sides (the first side surface 30s1 and the second side surface 30s2) of the radio-frequency circuit module 30. The third substrate side surface 20s3 and the fourth substrate side surface 20s4 of the antenna substrate 20 are provided along the two short sides (the third side surface 30s3 and the fourth side surface 30s4) of the radio-frequency circuit module 30.

In the following description, the first substrate side surface 20s1, the second substrate side surface 20s2, the third substrate side surface 20s3, and the fourth substrate side surface 20s4 of the antenna substrate 20 are referred to as the substrate side surfaces of the antenna substrate 20 when it is not necessary to distinguish therebetween. The first side surface 30s1, the second side surface 30s2, the third side surface 30s3, and the fourth side surface 30s4 of the radio-frequency circuit module 30 are referred to as the side surfaces of the radio-frequency circuit module 30 when it is not necessary to distinguish therebetween.

As illustrated in FIGS. 3 and 4, in plan view, the first substrate side surface 20s1 of the antenna substrate 20 is coplanar (e.g., aligned) with the first side surface 30s1 of the radio-frequency circuit module 30. The second substrate side surface 20s2 of the antenna substrate 20 that is opposite to the first substrate side surface 20s1 is in a region that does not overlap the radio-frequency circuit module 30, and is located outward (e.g., spaced apart in a direction oriented away) from the second side surface 30s2 of the radio-frequency circuit module 30 in the X direction.

As illustrated in FIG. 3, of the substrate side surfaces of the antenna substrate 20, the third substrate side surface 20s3 and the fourth substrate side surface 20s4 are provided in regions that do not overlap the radio-frequency circuit module 30 in plan view, and are located outward from the third side surface 30s3 and the fourth side surface 30s4 of the radio-frequency circuit module 30 in the Y direction. In other words, in plan view, the second side surface 30s2, the third side surface 30s3, and the fourth side surface 30s4 of the radio-frequency circuit module 30 are located in regions that overlap the antenna substrate 20 (e.g., the antenna substrate 20 extends beyond each of the second to fourth side surfaces 30s2 to 30s4).

As described above, the first substrate side surface 20s1 of the antenna substrate 20 is coplanar with the first side surface 30s1 of the radio-frequency circuit module 30. Accordingly, in the outer shape of the antenna module 10 in plan view, the dimensional accuracy of one long side of the antenna module 10 is determined by the first side surface 30s1 of the radio-frequency circuit module 30. The dimensional accuracies of the other sides of the antenna module 10 are determined by the second substrate side surface 20s2, the third substrate side surface 20s3, and the fourth substrate side surface 20s4 of the antenna substrate 20. Accordingly, even when misalignment of the first substrate side surface 20s1 occurs during cutting of the antenna substrate 20 into the outer shape thereof, the outer shape of the antenna module 10 is not affected, and the dimensional accuracy of at least one long side of the antenna module 10 can be increased.

Accordingly, the antenna module 10 has a higher dimensional accuracy in the width direction (X direction) compared to a case in which both the first side surface 30s1 and the second side surface 30s2 of the radio-frequency circuit module 30 are located inward from the substrate side surfaces of the antenna substrate 20.

Of the substrate side surfaces of the antenna substrate 20, the second substrate side surface 20s2, the third substrate side surface 20s3, and the fourth substrate side surface 20s4 are located outward from the radio-frequency circuit module 30. This allows the first principal surface 20a of the antenna substrate 20 to have a space for the connector 40 to be disposed. As a result, the area of the radiation electrodes 21 can be increased compared to a case in which the connector 40 is provided on the second principal surface 20b. Thus, according to the antenna module 10, the size of the antenna substrate 20 can be reduced, and the antenna frequency characteristics can be improved. In addition, in the antenna module 10, the outer shape (area) of the radio-frequency circuit module 30 is smaller than that of the antenna substrate 20. Accordingly, the size of the antenna module 10 can be reduced compared to a case in which an outer shape (area) of the radio-frequency circuit module 30 is larger than that of the antenna substrate 20, that is, a case in which the first side surface 30s1 and the second side surface 30s2 of the radio-frequency circuit module 30 are located outward from the substrate side surfaces of the antenna substrate 20.

As described above, the size of the antenna module 10 can be reduced, and the dimensional accuracy of the outer shape of the antenna module 10 can be increased.

The configuration of the antenna module 10 illustrated in FIGS. 1 to 4 is merely an example, and may be changed as appropriate. For example, although the long sides of the antenna substrate 20 are approximately four times or more and five times or less as long as the short sides of the antenna substrate 20, the ratio between the lengths of the long and short sides may be changed as appropriate. The ratio between the lengths of the long and short sides of the radio-frequency circuit module 30 may also be changed as appropriate.

### (Method for Manufacturing Antenna Module)

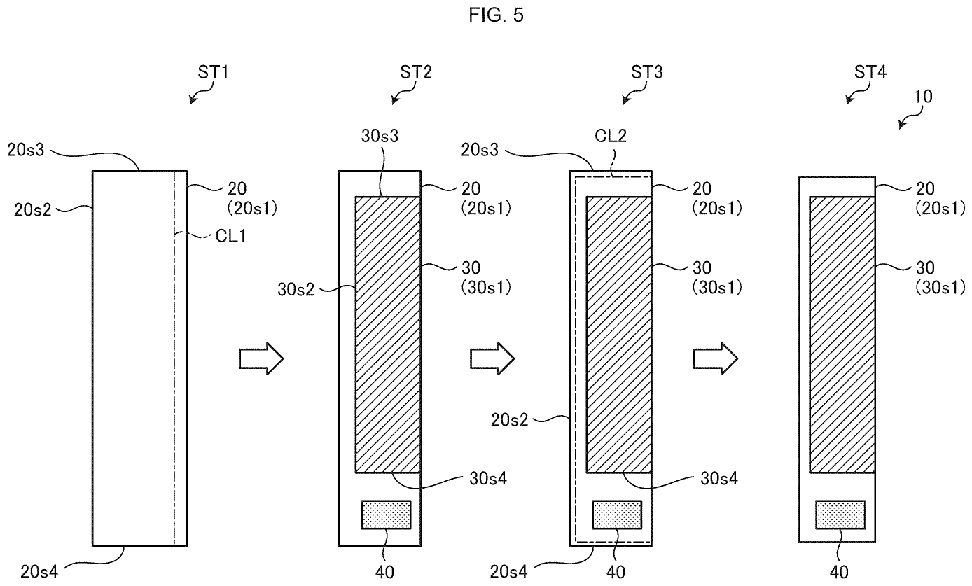

FIG. 5 illustrates a method for manufacturing the antenna module according to the first embodiment. As illustrated in FIG. 5, the antenna substrate 20 is prepared and cut along the first substrate side surface 20s1 among the substrate side surfaces of the antenna substrate 20 (step ST1). More specifically, one of the two long sides of the antenna substrate 20 is cut along a cutting line CL1 by laser processing or by machining using a dicer or the like. For example, the radiation electrodes 21, the ground electrode 22, and the wiring lines 23 (see FIG. 4) are formed on the surface layer and the inner layers of the antenna substrate 20 in advance.

Next, the radio-frequency circuit module 30 is mounted on the antenna substrate 20 such that the first substrate side surface 20s1 after the antenna substrate 20 has been cut is coplanar with the first side surface 30s1 corresponding to a long side of the radio-frequency circuit module 30 in plan view (step ST2). The unprocessed substrate side surfaces (the second substrate side surface 20s2, the third substrate side surface 20s3, and the fourth substrate side surface 20s4) of the antenna substrate 20 do not overlap the radio-frequency circuit module 30 and are located outward from the second side surface 30s2, the third side surface 30s3, and the fourth side surface 30s4 of the radio-frequency circuit module 30.

In step ST2, the connector 40 is mounted on the first principal surface 20a of the antenna substrate 20. In other words, the connector 40 is mounted on the same surface of the antenna substrate 20 as the radio-frequency circuit module 30.

Next, the antenna substrate 20 on which the radio-frequency circuit module 30 has been mounted is cut along the second substrate side surface 20s2, the third substrate side surface 20s3, and the fourth substrate side surface 20s4 (step ST3). More specifically, three sides (one long side and two short sides) of the antenna substrate 20 are cut along the cutting line CL2 by laser processing or by machining using a dicer or the like.

Although the antenna substrate 20 is cut along three sides in step ST3, this does not imply any limitation. The antenna substrate 20 is cut along at least one of the second substrate side surface 20s2, the third substrate side surface 20s3, and the fourth substrate side surface 20s4 in accordance with the required dimensional accuracy of the antenna module 10.

The above-described processes are performed to manufacture the antenna module 10 including the antenna substrate 20 cut into the outer shape thereof (step ST4). According to the method for manufacturing the antenna module 10 of the present embodiment, one of the long sides (first substrate side surface 20s1) of the antenna substrate 20 is cut before the radio-frequency circuit module 30 is mounted. The radio-frequency circuit module 30 is mounted after the first substrate side surface 20s1 is cut. Accordingly, the outer shape of at least one long side of the antenna module 10 is defined by the first side surface 30s1 of the radio-frequency circuit module 30. Thus, even when misalignment occurs during cutting of the first substrate side surface 20s1, the dimensional accuracy of the antenna module 10 can be increased.

The manufacturing method is schematically illustrated in FIG. 5, and may be changed as appropriate. For example, in step ST2, the first substrate side surface 20s1 of the antenna substrate 20 that has been cut is not necessarily coplanar with the first side surface 30s1 of the radio-frequency circuit module 30, and may be located inward from the first side surface 30s1.

### (First Modification)

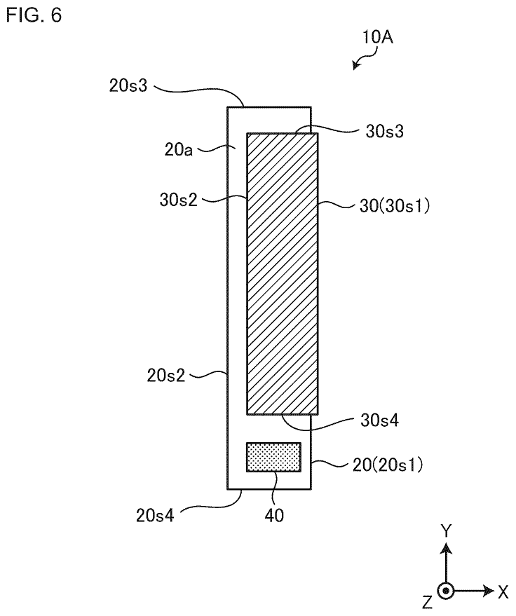

FIG. 6 is a plan view of an antenna module according to a first modification. As illustrated in FIG. 6, the antenna module 10A according to the first modification differs in configuration from that of the above-described first embodiment in that, in plan view, the first substrate side surface 20s1 of the antenna substrate 20 overlaps the radio-frequency circuit module 30 to be located inward from the first side surface 30s1.

In other words, the radio-frequency circuit module 30 is mounted on the antenna substrate 20 such that the first side surface 30s1 of the radio-frequency circuit module 30 does not overlap the antenna substrate 20 and protrudes outward from (e.g., overhangs) the first substrate side surface 20s1.

In the present modification, in the outer shape of the antenna module 10A in plan view, the dimensional accuracy of one long side of the antenna module 10A is determined only by the first side surface 30s1 of the radio-frequency circuit module 30. Accordingly, even when a large dimensional error occurs during cutting of the first substrate side surface 20s1 of the antenna substrate 20, the dimensional accuracy of the antenna module 10A in which the radio-frequency circuit module 30 is mounted can be increased.

### (Second Modification)

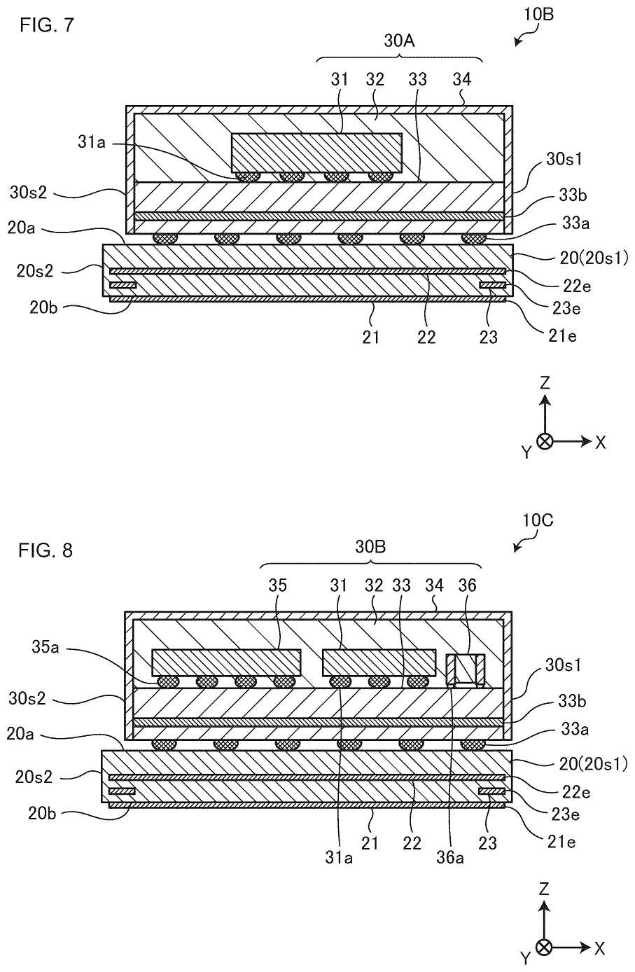

FIG. 7 is a sectional view of an antenna module according to a second modification. As illustrated in FIG. 7, the antenna module 10B according to the second modification differs in configuration from those of the above-described first embodiment and first modification in that a radio-frequency circuit module 30A includes a shield 34.

The radio-frequency circuit module 30A includes the circuit board 33, the RFIC 31 (radio-frequency circuit) provided on the circuit board 33, the mold resin 32 that covers the RFIC 31, and the shield 34 that covers an upper surface and side surfaces of the mold resin 32. The shield 34 is made of a conductive material, for example, a metallic material, such as aluminum (Al), copper (Cu), gold (Au), or silver (Ag), or an alloy containing these materials.

The shield 34 is provided on (e.g., directly on) the upper and side surfaces of the radio-frequency circuit module 30A. More specifically, the shield 34 covers the upper and side surfaces of the mold resin 32, and also covers the side surfaces of the circuit board 33. The shield 34 is not provided on (e.g., directly on) the antenna substrate 20. In the present modification, side surfaces of the shield 34 define the side surfaces (the first side surface 30s1, the second side surface 30s2, the third side surface 30s3, and the fourth side surface 30s4) of the radio-frequency circuit module 30A. The shield 34 may also be provided on the third side surface 30s3 and the fourth side surface 30s4.

Accordingly, in the second modification, the shield 34 can reduce noise from the RFIC 31, the wiring line 33b, and other elements of the radio-frequency circuit module 30A. In another respect, in the second modification, the shield 34 can reduce noise interference between the radio-frequency circuit module 30A and the radiation electrodes 21 of the antenna substrate 20.

### (Third Modification)

FIG. 8 is a sectional view of an antenna module according to a third modification. As illustrated in FIG. 8, the antenna module 10C according to the third modification differs in configuration from those of the above-described first embodiment and modifications in that a radio-frequency circuit module 30B includes a power supply IC 35 and a chip component 36 in addition to the RFIC 31.

The power supply IC 35 includes, for example, a power amplifier and supplies a power supply voltage to the RFIC 31. The chip component 36 is, for example, a resistor, a capacitor, or an inductor. Although one power supply IC 35 and one chip component 36 are illustrated in FIG. 8, a plurality of ICs other than the RFIC 31 and a plurality of chip components may be provided. In another respect, the radio-frequency circuit module 30B does not necessarily include both the power supply IC 35 and the chip component 36. The radio-frequency circuit module 30B includes, in addition to the RFIC 31, at least one of an IC different from the RFIC 31 and the chip component 36.

The power supply IC 35 and the chip component 36 are mounted on the same circuit board 33 as the RFIC 31 with respective connection terminals 35a and 36a. The mold resin 32 and the shield 34 cover the RFIC 31, the power supply IC 35, and the chip component 36.

In the present modification, a plurality of components including the RFIC 31, the power supply IC 35, and the chip component 36 are integrally packaged together and mounted on the antenna substrate 20. Thus, the size of the antenna module 10C can be reduced compared to a case in which the RFIC 31, the power supply IC 35, and the chip component 36 are individually mounted on the antenna substrate 20.

### (Fourth Modification)

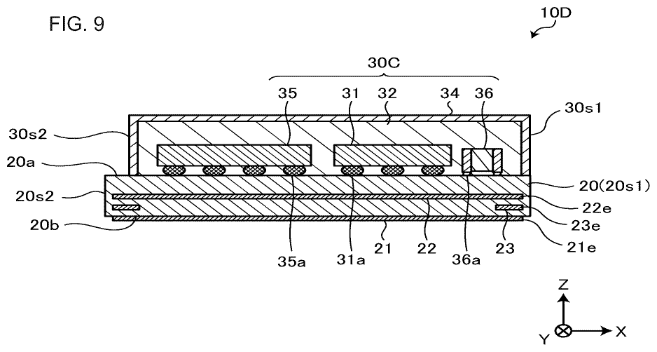

FIG. 9 is a sectional view of an antenna module according to a fourth modification. As illustrated in FIG. 9, the antenna module 10D according to the fourth modification differs in configuration from those of the above-described first embodiment and modifications in that a radio-frequency circuit module 30C includes no circuit board 33.

The radio-frequency circuit module 30C includes the radio-frequency circuit including the RFIC 31, the power supply IC 35, and the chip component 36; the mold resin 32; and the shield 34. The mold resin 32 covers the radio-frequency circuit (the RFIC 31, the power supply IC 35, and the chip component 36). The shield 34 covers the upper and side surfaces of the mold resin 32.

The radio-frequency circuit module 30C is a so-called interposer-less module. The radio-frequency circuit module 30C is formed by integrally packaging the radio-frequency circuit (the RFIC 31, the power supply IC 35, and the chip component 36), the mold resin 32, and the shield 34, and is mounted on the antenna substrate 20. In other words, the RFIC 31, the power supply IC 35, and the chip component 36 are directly mounted on the first principal surface 20a of the antenna substrate 20 with the respective connection terminals 31a, 35a, and 36a. For example, connection electrodes are provided on the first principal surface 20a of the antenna substrate 20 at locations corresponding to the locations (arrangement pitch) of the connection terminals 31a, 35a, and 36a.

In the fourth modification, unlike the above-described first embodiment and modifications, the radio-frequency circuit module 30C includes no circuit board 33. Accordingly, the radio-frequency circuit module 30C can be reduced in size and thickness.

In the above first to fourth modifications, the radio-frequency circuit modules 30, 30A, 30B, and 30C according to various modifications have been described. These configurations may be combined as appropriate. For example, the radio-frequency circuit modules 30B and 30C (see FIGS. 8 and 9) may include no shield 34. Although one of the radio-frequency circuit modules 30, 30A, 30B, and 30C will be described in the following embodiments and modifications, this does not imply any limitation, and another one of the radio-frequency circuit modules 30, 30A, 30B, and 30C having a different configuration may be applied.

### Second Embodiment

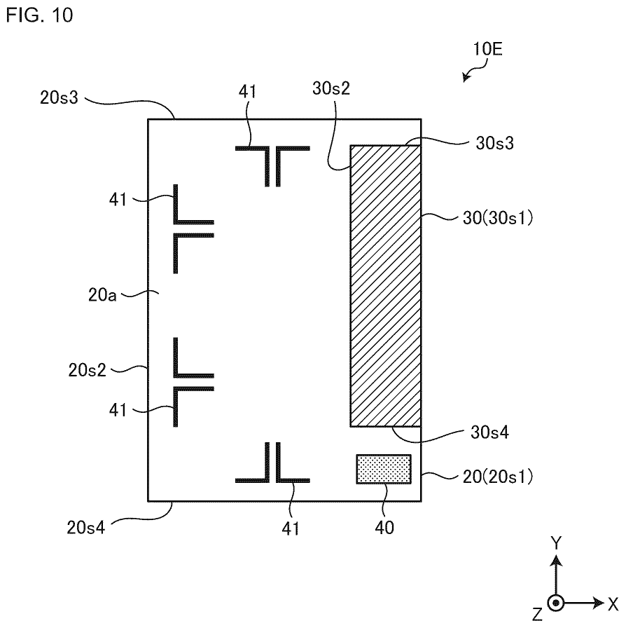

FIG. 10 is a plan view of an antenna module according to a second embodiment. As illustrated in FIG. 10, the antenna module 10E according to the second embodiment differs in configuration from those of the above-described first embodiment and modifications in that antenna elements 41 are provided in addition to the radiation electrodes 21.

The antenna elements 41 are radiation electrodes different from the radiation electrodes 21 (see FIG. 2), and are provided on the first principal surface 20a of the antenna substrate 20 at the side opposite to the side at which the radiation electrodes 21 are provided. The antenna elements 41 have a radiation pattern with a directivity in a direction parallel to the first principal surface 20a of the antenna substrate 20. The antenna elements 41 are, for example, dipole antennas. However, the antenna elements 41 are not limited to this, and may have other structures as long as the antenna elements 41 have a directivity in a horizontal direction.

The width of the antenna substrate 20 in the X direction is greater than the width in the above-described first embodiment and modifications. The antenna elements 41 are provided in a region that does not overlap the radio-frequency circuit module 30 and the connector 40 on the antenna substrate 20, as viewed in plan view. The antenna elements 41 are disposed on the first principal surface 20a of the antenna substrate 20 in regions along the second substrate side surface 20s2, the third substrate side surface 20s3, and the fourth substrate side surface 20s4.

The antenna module 10E according to the present embodiment includes the radiation electrodes 21 and the antenna elements 41, which form a horizontal radiation pattern. Thus, according to the present embodiment, the radiation pattern of the radiation electrodes 21 and the antenna elements 41 has a greater coverage than that in the above-described first embodiment and modifications.

The number and arrangement pattern of the antenna elements 41 are merely examples, and may be changed as appropriate in accordance with the required radiation pattern of the antenna module 10E.

### (Fifth Modification)

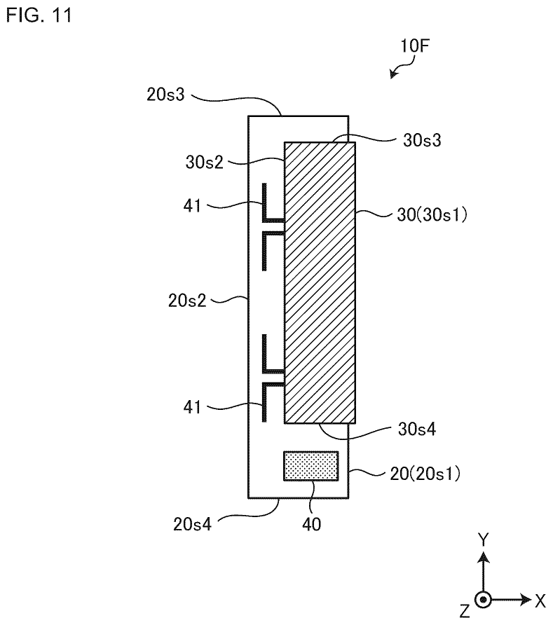

FIG. 11 is a plan view of an antenna module according to a fifth modification. As illustrated in FIG. 11, the antenna module 10F according to the fifth modification differs in configuration from that of the above-described second embodiment in that the antenna elements 41 are disposed on the first principal surface 20a of the antenna substrate 20 in a region along the second substrate side surface 20s2 but are not provided in regions along the third substrate side surface 20s3 and the fourth substrate side surface 20s4.

In the fifth modification, the width of the antenna substrate 20 in the X direction is less than that in the above-described second embodiment. In plan view, the first substrate side surface 20s1 of the antenna substrate 20 overlaps the radio-frequency circuit module 30A and is located inward from the first side surface 30s1 of the radio-frequency circuit module 30A. In other words, in plan view, the first side surface 30s1 of the radio-frequency circuit module 30A does not overlap the antenna substrate 20 and is located outward from the first substrate side surface 20s1 of the antenna substrate 20. The antenna elements 41 are disposed in a region between the second side surface 30s2 of the radio-frequency circuit module 30A and the second substrate side surface 20s2 of the antenna substrate 20.

Thus, according to the present modification, the size of the antenna module 10F can be reduced, and the first principal surface 20a of the antenna substrate 20 has a region for the antenna elements 41 to be disposed.

### Third Embodiment

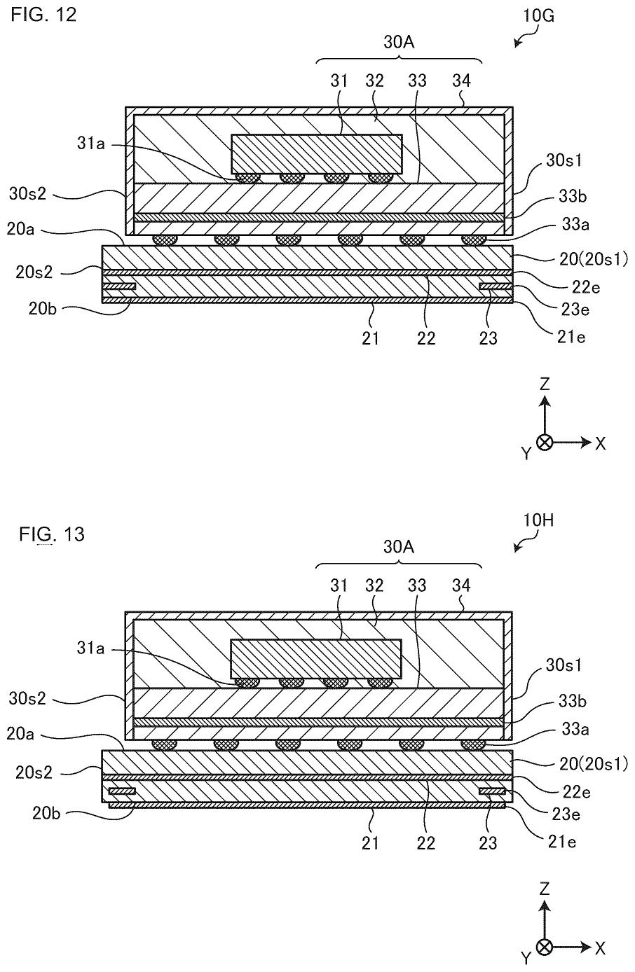

FIG. 12 is a sectional view of an antenna module according to a third embodiment. As illustrated in FIG. 12, the antenna module 10G according to the third embodiment differs in configuration from those of the above-described embodiments and modifications in that the electrodes (the radiation electrodes 21, the ground electrode 22, and the wiring lines 23) provided on the surface layer and the inner layers of the antenna substrate 20 are exposed at the substrate side surfaces of the antenna substrate 20.

More specifically, the end surfaces 21e of the radiation electrodes 21, the end surfaces 22e of the ground electrode 22, and the end surfaces 23e of the wiring lines 23 are coplanar with the first substrate side surface 20s1 and the second substrate side surface 20s2 of the antenna substrate 20.

According to the present modification, the size of the antenna substrate 20 can be reduced, and the radiation electrodes 21 and the ground electrode 22 can have sufficient areas. Thus, according to the antenna module 10G of the third embodiment, the antenna gain, the frequency characteristics, and the bandwidth can be improved.

### (Sixth Modification)

FIG. 13 is a sectional view of an antenna module according to a sixth modification. As illustrated in FIG. 13, the antenna module 10H according to the sixth modification differs in configuration from that of the above-described third embodiment in that the ground electrode 22 provided on an inner layer of the antenna substrate 20 is exposed at the substrate side surfaces of the antenna substrate 20 while the radiation electrodes 21 and the wiring lines 23 are located inward from the substrate side surfaces of the antenna substrate 20.

More specifically, the end surfaces 22e of the ground electrode 22 are coplanar with the first substrate side surface 20s1 and the second substrate side surface 20s2 of the antenna substrate 20. The end surfaces 21e of the radiation electrodes 21 and the end surfaces 23e of the wiring lines 23 are located inward from the first substrate side surface 20s1 and the second substrate side surface 20s2 of the antenna substrate 20.

In the present modification, the area of the ground electrode 22 relative to the area of the radiation electrodes 21 is larger than that in the above-described third embodiment. A fringe electric field is generated from the end surfaces 21e of the radiation electrodes 21 toward the end surfaces 22e of the ground electrode 22, and this fringe electric field causes radiation of radio waves in the direction normal to the radiation electrodes 21. Thus, according to the antenna module 10H of the sixth modification, the antenna gain can be improved.

### (Seventh Modification)

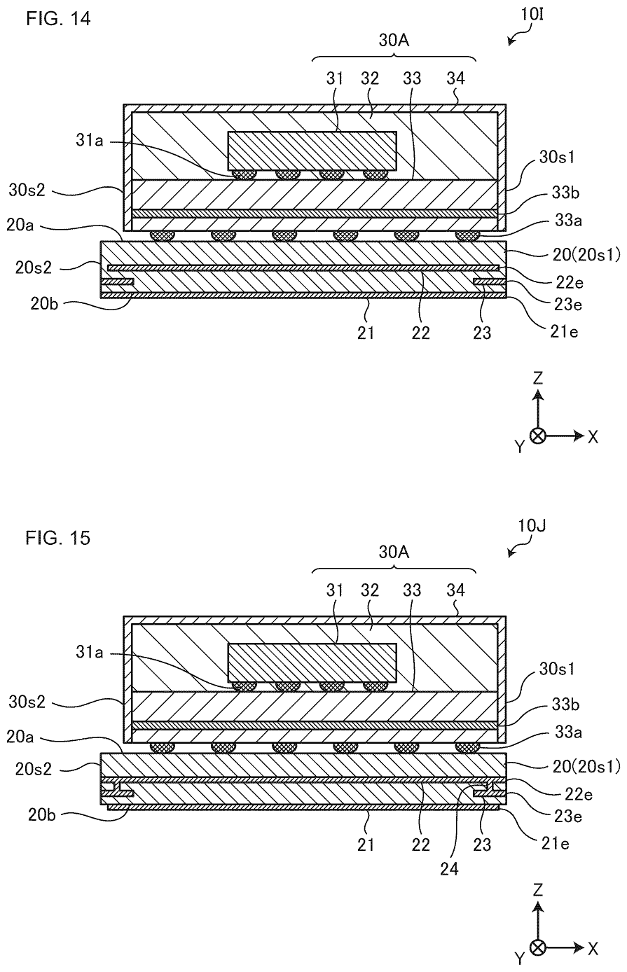

FIG. 14 is a sectional view of an antenna module according to a seventh modification. As illustrated in FIG. 14, the antenna module 10I according to the seventh modification differs in configuration from those of the above-described third embodiment and sixth modification in that the radiation electrodes 21 and the wiring lines 23 are exposed at the substrate side surfaces of the antenna substrate 20, and the ground electrode 22 provided on an inner layer of the antenna substrate 20 is located inward from the substrate side surfaces of the antenna substrate 20.

More specifically, the end surfaces 21e of the radiation electrodes 21 and the end surfaces 23e of the wiring lines 23 are coplanar with the first substrate side surface 20s1 and the second substrate side surface 20s2 of the antenna substrate 20. The end surfaces 22e of the ground electrode 22 are located inward from the first substrate side surface 20s1 and the second substrate side surface 20s2 of the antenna substrate 20.

In the present modification, the area of the radiation electrodes 21 relative to the area of the ground electrode 22 is larger than that in the above-described third embodiment and sixth modification. Thus, according to the antenna module 10I of the seventh modification, the size of the antenna substrate 20 can be reduced, and the antenna frequency characteristics can be improved. In particular, since the area of the radiation electrodes 21 is increased, the antenna frequency characteristics at the low-frequency side can be improved.

### (Eighth Modification)

FIG. 15 is a sectional view of an antenna module according to an eighth modification. As illustrated in FIG. 15, the antenna module 10J according to the eighth modification differs in configuration from those of the above-described third embodiment, sixth modification, and seventh modification in that the wiring lines 23 provided on an inner layer of the antenna substrate 20 are connected to the ground electrode 22 by vias 24. In the eighth modification, the ground electrode 22 and the wiring lines 23 provided on the inner layers of the antenna substrate 20 are exposed at the substrate side surfaces of the antenna substrate 20, and the radiation electrodes 21 are located inward from the substrate side surfaces of the antenna substrate 20.

More specifically, the end surfaces 22e of the ground electrode 22 and the end surfaces 23e of the wiring lines 23 are coplanar with the first substrate side surface 20s1 and the second substrate side surface 20s2 of the antenna substrate 20. The end surfaces 21e of the radiation electrodes 21 are located inward from the first substrate side surface 20s1 and the second substrate side surface 20s2 of the antenna substrate 20.

In the present modification, unlike the above-described third embodiment, sixth modification, and seventh modification, the wiring lines 23 are connected to the ground electrode 22. In addition, in the Z direction, the wiring lines 23 are disposed between the radiation electrodes 21 and the ground electrode 22. Accordingly, the distance from the radiation electrodes 21 to the ground potential (wiring lines 23) is shorter than the distance from the radiation electrodes 21 to the ground potential (ground electrode 22) in a configuration in which the wiring lines 23 are not connected to the ground electrode 22. Accordingly, an electric field is more readily generated between the radiation electrodes 21 and the wiring lines 23, and generation of the fringe electric field from the end surfaces 21e of the radiation electrodes 21 toward the end surfaces 22e of the ground electrode 22 along the substrate side surfaces of the antenna substrate 20 is reduced. Thus, according to the antenna module 10J of the eighth modification, the size of the antenna substrate 20 can be reduced, and the antenna bandwidth can be improved.

### Fourth Embodiment

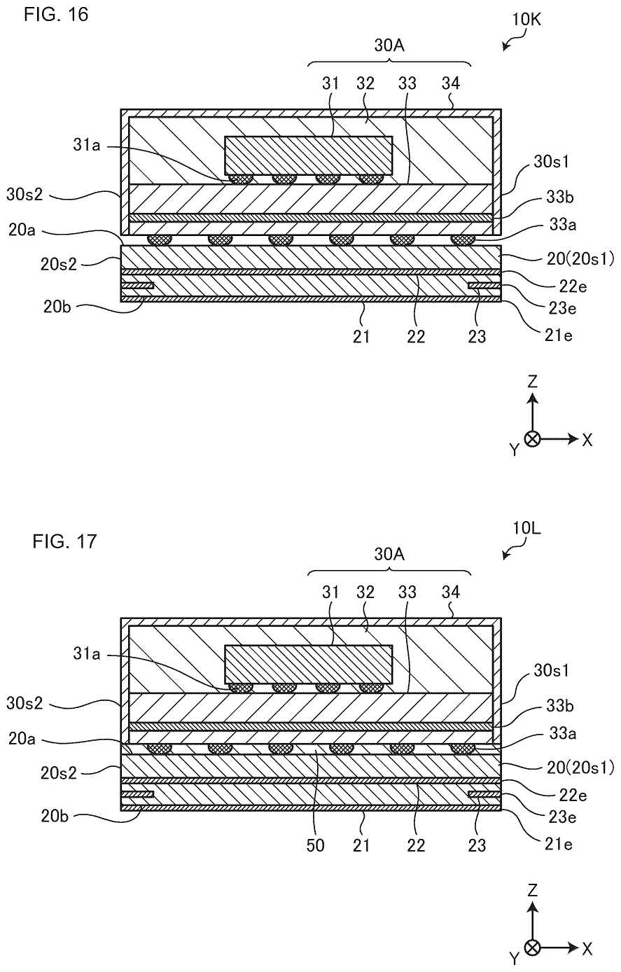

FIG. 16 is a sectional view of an antenna module according to a fourth embodiment. As illustrated in FIG. 16, the antenna module 10K according to the fourth embodiment differs in configuration from those of the above-described embodiments and modifications in that, in plan view, the first substrate side surface 20s1 and the second substrate side surface 20s2 of the antenna substrate 20 are coplanar with the first side surface 30s1 and the second side surface 30s2, respectively, of the radio-frequency circuit module 30A.

For example, in plan view, the third substrate side surface 20s3 and the fourth substrate side surface 20s4 of the antenna substrate 20 are located outward from the third side surface 30s3 and the fourth side surface 30s4 (see FIG. 3) of the radio-frequency circuit module 30A.

According to the present embodiment, in the outer shape of the antenna module 10K in plan view, the dimensional accuracies of the two long sides of the antenna module 10K are determined by the first side surface 30s1 and the second side surface 30s2 of the radio-frequency circuit module 30A. Accordingly, even when misalignment of the first substrate side surface 20s1 and the second substrate side surface 20s2 occurs during cutting of the antenna substrate 20 into the outer shape thereof, the outer shapes of the two long sides of the antenna module 10K are not affected. As a result, the size of the antenna module 10K in the X direction can be reduced, and the dimensional accuracy can be improved.

In the fourth embodiment, the first substrate side surface 20s1 and the second substrate side surface 20s2 of the antenna substrate 20 may be located inward from the first side surface 30s1 and the second side surface 30s2, respectively, of the radio-frequency circuit module 30A in plan view.

### Fifth Embodiment

FIG. 17 is a sectional view of an antenna module according to a fifth embodiment. As illustrated in FIG. 17, the antenna module 10L according to the fifth embodiment differs in configuration from those of the above-described embodiments and modifications in that a resin layer 50 is provided between the antenna substrate 20 and the radio-frequency circuit module 30A.

More specifically, the resin layer 50 is provided to fill the gap between the first principal surface 20a of the antenna substrate 20 and the lower surface (surface facing the first principal surface 20a) of the circuit board 33. The resin layer 50 can increase the connection strength between the antenna substrate 20 and the radio-frequency circuit module 30A.

The antenna substrate 20 and the radio-frequency circuit module 30A according to the present embodiment have the same configurations as those in the above-described fourth embodiment. That is, in plan view, the first substrate side surface 20s1 and the second substrate side surface 20s2 of the antenna substrate 20 are coplanar with the first side surface 30s1 and the second side surface 30s2, respectively, of the radio-frequency circuit module 30A. Thus, no fillet is formed on the resin layer 50. In other words, the end surfaces of the resin layer 50 are coplanar with the first substrate side surface 20s1 and the second substrate side surface 20s2 and do not protrude from the first substrate side surface 20s1 and the second substrate side surface 20s2 of the antenna substrate 20. Accordingly, the resin layer 50 can be provided to increase the connection strength without increasing the outer shape of the antenna module 10L.

The resin layer 50 of the present embodiment may be applied to the above-described first to third embodiments and modifications.

### (Ninth Modification)

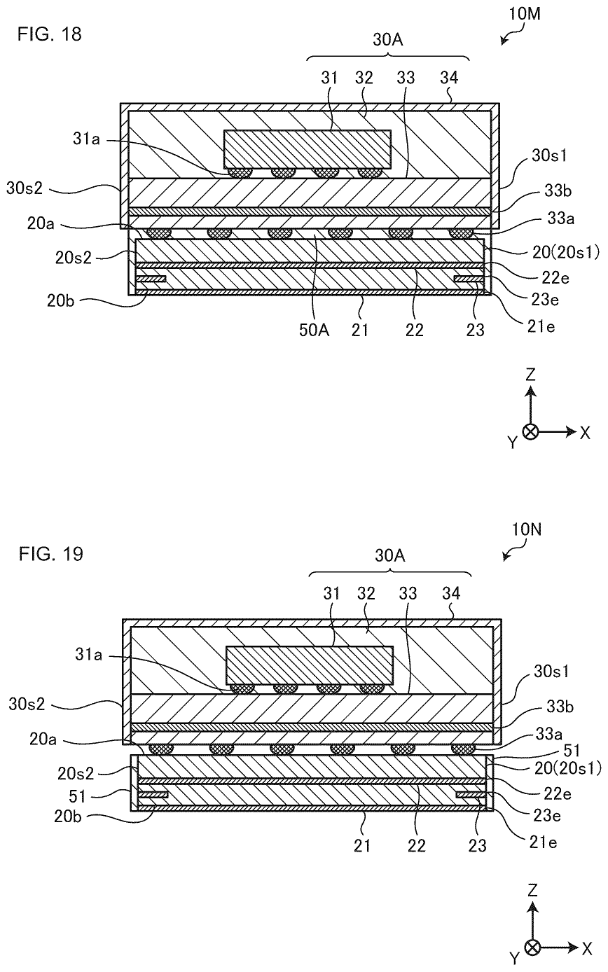

FIG. 18 is a sectional view of an antenna module according to a ninth modification. As illustrated in FIG. 18, the antenna module 10M according to the ninth modification differs in configuration from that of the above-described fifth embodiment in that a resin layer 50A is provided to fill the gap between the antenna substrate 20 and the radio-frequency circuit module 30A and cover the substrate side surfaces of the antenna substrate 20.

More specifically, the resin layer 50A is provided to fill the gap between the first principal surface 20a of the antenna substrate 20 and the lower surface (surface facing the first principal surface 20a) of the circuit board 33 and cover the first substrate side surface 20s1 and the second substrate side surface 20s2 of the antenna substrate 20. The resin layer 50A may also cover the third substrate side surface 20s3 and the fourth substrate side surface 20s4 of the antenna substrate 20.

The resin layer 50A can increase the connection strength between the antenna substrate 20 and the radio-frequency circuit module 30A. The resin layer 50A also covers the end surfaces 21e of the radiation electrodes 21, the end surfaces 22e of the ground electrode 22, and the end surfaces 23e of the wiring lines 23, which are exposed at the substrate side surfaces of the antenna substrate 20. In the present modification, the resin layer 50A can also reduce oxidation of the radiation electrodes 21, the ground electrode 22, and the wiring lines 23, which are exposed at the substrate side surfaces of the antenna substrate 20.

The resin layer 50A of the present modification may be applied to the above-described first to third embodiments and modifications.

### (Tenth Modification)

FIG. 19 is a sectional view of an antenna module according to a tenth modification. As illustrated in FIG. 19, the antenna module 10N according to the tenth modification differs in configuration from those of the above-described embodiments and modifications in that an insulating layer 51 is provided on the substrate side surfaces of the antenna substrate 20. The insulating layer 51 is formed of a material different from the material of the antenna substrate 20.

The insulating layer 51 is provided to cover the first substrate side surface 20s1 and the second substrate side surface 20s2 of the antenna substrate 20. The insulating layer 51 may also cover the third substrate side surface 20s3 and the fourth substrate side surface 20s4 of the antenna substrate 20.

The end surfaces 21e of the radiation electrodes 21, the end surfaces 22e of the ground electrode 22, and the end surfaces 23e of the wiring lines 23, which are exposed at the substrate side surfaces of the antenna substrate 20, are covered by the insulating layer 51. Accordingly, in the present modification, oxidation of the radiation electrodes 21, the ground electrode 22, and the wiring lines 23, which are exposed at the substrate side surfaces of the antenna substrate 20, can be reduced by the insulating layer 51.

The insulating layer 51 of the present modification may be applied to the above-described first to third embodiments and modifications. In addition, the insulating layer 51 of the present modification may be combined with the resin layers 50 and 50A according to the fifth embodiment and the ninth modification.

### (Eleventh Modification)

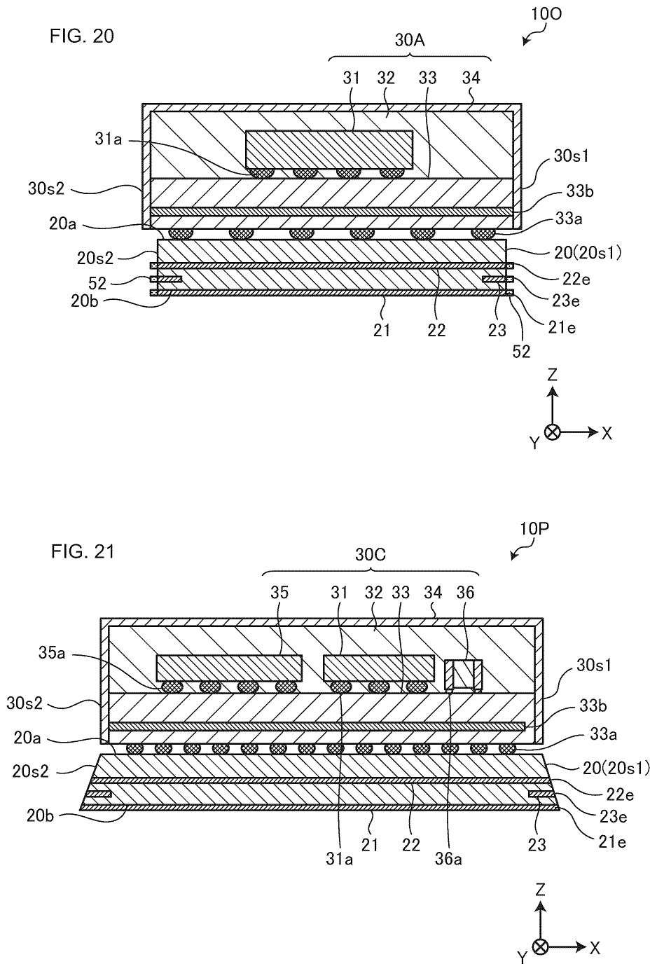

FIG. 20 is a sectional view of an antenna module according to an eleventh modification. As illustrated in FIG. 20, the antenna module 10O according to the eleventh modification differs in configuration from those of the above-described embodiments and modifications in that a plating layer 52 is provided to cover the electrodes (the radiation electrodes 21, the ground electrode 22, and the wiring lines 23) exposed at the substrate side surfaces of the antenna substrate 20.

The plating layer 52 is provided to cover the end surfaces 21e of the radiation electrodes 21, the end surfaces 22e of the ground electrode 22, and the end surfaces 23e of the wiring lines 23, which are exposed at the substrate side surfaces of the antenna substrate 20 (e.g., the plating layer 52 may be colinear (e.g., coextensive) with each of the radiation electrodes 21, the ground electrode 22, and the wiring lines 23 outside each of the first and second substrate side surfaces 20s1 and 20s2 of the antenna substrate 20). In the present modification, oxidation of the radiation electrodes 21, the ground electrode 22, and the wiring lines 23, which are exposed at the substrate side surfaces of the antenna substrate 20, can be reduced by the plating layer 52.

The plating layer 52 according to the present modification may be combined with each of the above-described third embodiment (see FIG. 12) and sixth to eighth modifications (see FIG. 13 to FIG. 15). In this case, among the electrodes (the radiation electrodes 21, the ground electrode 22, and the wiring lines 23) provided in or on the antenna substrate 20, the electrodes exposed at the substrate side surfaces of the antenna substrate 20 have the plating layer 52 formed on the end surfaces thereof. The plating layer 52 of the present modification may be combined with one or more of the resin layers 50 and 50A and the insulating layer 51 according to the fifth embodiment and the ninth and tenth modifications.

### Sixth Embodiment

FIG. 21 is a sectional view of an antenna module according to a sixth embodiment. As illustrated in FIG. 21, the antenna module 10P according to the sixth embodiment differs in configuration from those of the above-described embodiments and modifications in that the first substrate side surface 20s1 and the second substrate side surface 20s2 of the antenna substrate 20 are inclined in a tapered manner.

In the sixth embodiment, the first substrate side surface 20s1 and the second substrate side surface 20s2 of the antenna substrate 20 are inclined in a forward-tapered manner. In other words, the width of the first principal surface 20a of the antenna substrate 20 in the X direction is less than the width of the second principal surface 20b in the X direction.

The radiation electrodes 21, the ground electrode 22, and the wiring lines 23 provided in or on the antenna substrate 20 are exposed at the substrate side surfaces of the antenna substrate 20. Accordingly, in the present embodiment, the size of the antenna substrate 20 can be reduced, and the area of the radiation electrodes 21 can be increased. As a result, the antenna characteristics of the antenna module 10P at the low-frequency side can be improved.

The configuration of the antenna substrate 20 according to the present embodiment may be combined with the above-described first to fifth embodiments and modifications.

### (Twelfth Modification)

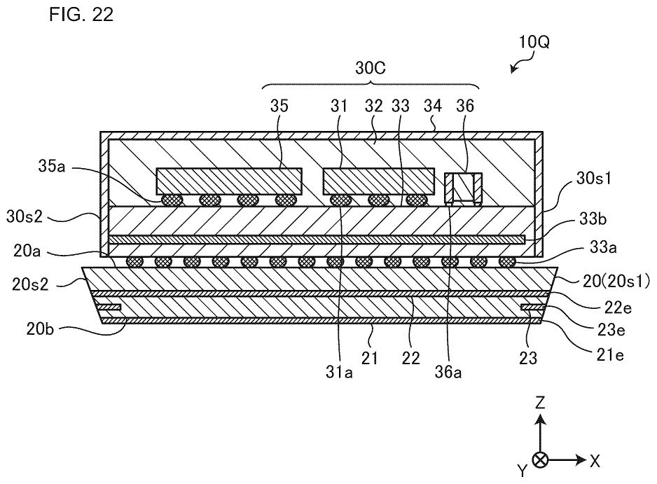

FIG. 22 is a sectional view of an antenna module according to a twelfth modification. As illustrated in FIG. 22, the antenna module 10Q according to the twelfth modification differs in configuration from that in the above-described sixth embodiment in that the first substrate side surface 20s1 and the second substrate side surface 20s2 of the antenna substrate 20 are inclined in a reverse-tapered manner. In other words, the width of the first principal surface 20a of the antenna substrate 20 in the X direction is greater than the width of the second principal surface 20b in the X direction.

Also in the present modification, the radiation electrodes 21, the ground electrode 22, and the wiring lines 23 provided in or on the antenna substrate 20 are exposed at the substrate side surfaces of the antenna substrate 20. Accordingly, in the present modification, the size of the antenna substrate 20 can be reduced, and the ground electrode 22 has an area greater than that of the radiation electrodes 21. As a result, according to the antenna module 10Q, the antenna gain can be increased.

The configuration of the antenna substrate 20 according to the present modification may be combined with the above-described first to fifth embodiments and modifications.

### Seventh Embodiment

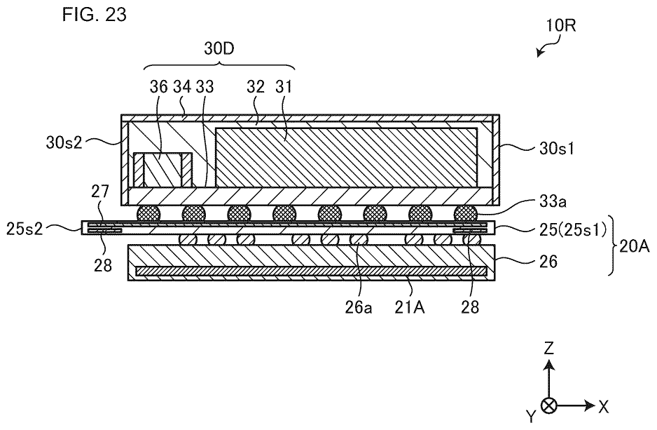

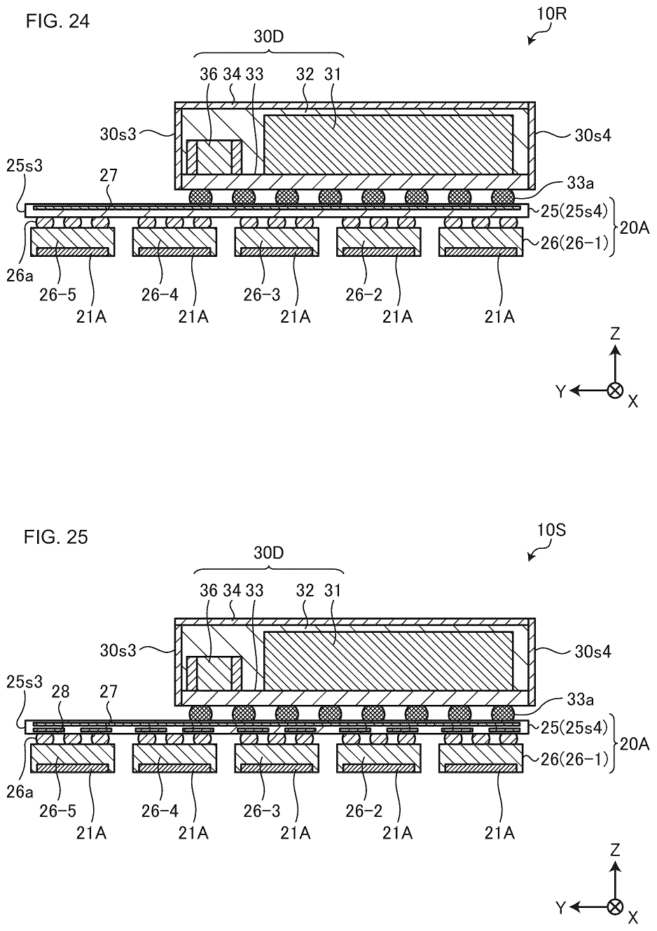

FIG. 23 is a sectional view of an antenna module according to a seventh embodiment. FIG. 24 is a sectional view of the antenna module according to the seventh embodiment taken along the Y direction. As illustrated in FIGS. 23 and 24, the antenna module 10R according to the seventh embodiment differs in configuration from those of the above-described embodiments and modifications in that the antenna substrate 20A includes a first antenna substrate 25 and second antenna substrates 26.

In the antenna module 10R according to the present embodiment, the second antenna substrates 26, the first antenna substrate 25, and the radio-frequency circuit module 30D are laminated in that order in the Z direction. In other words, the first antenna substrate 25 is disposed between the radio-frequency circuit module 30D and the second antenna substrates 26 in the Z direction. The first antenna substrate 25 is a so-called interposer substrate.

The radio-frequency circuit module 30D includes the circuit board 33; the RFIC 31 (radio-frequency circuit) and the chip component 36 provided on the circuit board 33; the mold resin 32 that covers the RFIC 31 and the chip component 36; and the shield 34 that covers the upper and side surfaces of the mold resin 32. The chip component 36 is a resistor, a capacitor, an inductor, or another element required for the operation of the RFIC 31. The radio-frequency circuit module 30D is formed by integrally packaging the circuit board 33, the radio-frequency circuit including the RFIC 31, the chip component 36, the mold resin 32, and the shield 34 and is mounted on the first antenna substrate 25 of the antenna substrate 20A.

The circuit board 33 of the radio-frequency circuit module 30D is mounted on one principal surface of the first antenna substrate 25 with connection terminals 33a (bumps). The second antenna substrates 26 are connected to the other principal surface of the first antenna substrate 25 with connection terminals 26a (bumps). The radio-frequency circuit module 30D is electrically connected to radiation electrodes 21A provided on the second antenna substrates 26 through wiring lines and vias provided in or on the first antenna substrate 25.

A ground electrode 27 and wiring lines 28 are provided in the first antenna substrate 25. The ground electrode 27 and the wiring lines 28 are provided on inner layers of the first antenna substrate 25. The first antenna substrate 25 is thinner than each of the second antenna substrates 26 (in the Z direction).

The material of dielectric layers of the first antenna substrate 25 is, for example, any one or more of low temperature co-fired ceramics (LTCC), glass epoxy resin, liquid crystal polymer (LCP), fluorocarbon resin, and polyimide resin. For example, the first antenna substrate 25 is made of liquid crystal polymer. The ground electrode 27 and the wiring lines 28 are similar to the ground electrode 22 and the wiring lines 23, respectively, of the above-described antenna substrate 20, and are made of a conductive metallic material.

The radiation electrodes 21A are provided on the second antenna substrates 26. The radiation electrodes 21A are provided on lower surfaces (surfaces opposite to the surfaces facing the first antenna substrate 25) of the second antenna substrates 26. The material of dielectric layers of the second antenna substrates 26 may be similar to the material of the above-described antenna substrate 20. The material of the radiation electrodes 21A may be similar to the material of the radiation electrodes 21 on the above-described antenna substrate 20.

As illustrated in FIG. 24, the antenna module 10R includes a plurality of second antenna substrates 26-1, 26-2, 26-3, 26-4, and 26-5. The second antenna substrates 26-1, 26-2, 26-3, 26-4, and 26-5 are arranged along the Y direction on the other principal surface of the first antenna substrate 25. One of the radiation electrodes 21A is provided on each of the second antenna substrates 26-1, 26-2, 26-3, 26-4, and 26-5.

In the following description, the second antenna substrates 26-1, 26-2, 26-3, 26-4, and 26-5 are simply referred to as the second antenna substrates 26 when it is not necessary to distinguish therebetween.

In the antenna module 10R of the present embodiment, the first antenna substrate 25 has a first substrate side surface 25s1, a second substrate side surface 25s2, a third substrate side surface 25s3, and a fourth substrate side surface 25s4 corresponding to the first substrate side surface 20s1, the second substrate side surface 20s2, the third substrate side surface 20s3, and the fourth substrate side surface 20s4, respectively, of the above-described antenna substrate 20.

In plan view, the first substrate side surface 25s1 of the first antenna substrate 25 is coplanar with the first side surface 30s1 of the radio-frequency circuit module 30D, or overlaps the radio-frequency circuit module 30D to be located inward from the first side surface 30s1. Of the substrate side surfaces of the first antenna substrate 25, at least the second substrate side surface 25s2 and the third substrate side surface 25s3 are disposed in regions that do not overlap the radio-frequency circuit module 30D in plan view. The second substrate side surface 25s2 is located outward from the second side surface 30s2 of the radio-frequency circuit module 30D in the X direction. The third substrate side surface 25s3 is located outward from the third side surface 30s3 of the radio-frequency circuit module 30D in the Y direction.

Accordingly, similarly to the above-described embodiments, the antenna module 10R of the present embodiment also has an increased dimensional accuracy.

The antenna module 10R according to the present embodiment includes the first antenna substrate 25, which provides a relay between the radio-frequency circuit module 30D and the second antenna substrates 26 on which the radiation electrodes 21A are provided. This allows for increased flexibility in determining, for example, the material and size of the second antenna substrate 26 and the size of the radiation electrodes 21A. As a result, the antenna module 10R can have improved performance and a broader bandwidth.

For example, the second antenna substrates 26 and the first antenna substrate 25 may be made of different materials, and a plurality of second antenna substrates 26 may be readily mounted on a single first antenna substrate 25. Even when the number, arrangement pitch, or the like of the second antenna substrates 26 (radiation electrodes 21A) is changed, the first antenna substrate 25 can provide a reliable connection between the radio-frequency circuit module 30D and the second antenna substrates 26. In addition, even when the number and arrangement pitch of the connection terminals 33a (bumps) on the radio-frequency circuit module 30D differ from the number and arrangement pitch of the connection terminals 26a (bumps) on the second antenna substrates 26, the first antenna substrate 25 can provide a reliable connection between the radio-frequency circuit module 30D and the second antenna substrates 26.

The first antenna substrate 25 is, for example, a thin flexible substrate made of liquid crystal polymer. Accordingly, even when the antenna module 10R is subjected to stress, stress concentration on the first antenna substrate 25 can be reduced, so that damage, such as breakage, in the first antenna substrate 25 is less likely to occur.

The configuration of the antenna module 10R according to the present embodiment is merely an example, and may be changed as appropriate. For example, the configuration of the radio-frequency circuit module 30D is not limited to the example illustrated in FIGS. 23 and 24, and may be one of the above-described radio-frequency circuit modules 30, 30A, 30B, and 30C. The configurations of the first antenna substrate 25 and the second antenna substrate 26 illustrated in FIGS. 23 and 24 are also merely examples, and may be changed as appropriate.

### (Thirteenth Modification)

FIG. 25 is a sectional view of an antenna module according to a thirteenth modification taken along the Y direction. As illustrated in FIG. 25, the antenna module 10S according to the thirteenth modification differs in configuration from the above-described seventh embodiment in that the wiring lines 28 in the first antenna substrate 25 are arranged along the Y direction. More specifically, the wiring lines 28 are provided to correspond to respective ones of the second antenna substrates 26-1, 26-2, 26-3, 26-4, and 26-5 arranged along the Y direction. The pattern, number, and the like of the wiring lines and the electrodes provided in the first antenna substrate 25 can be changed as appropriate.

### (Fourteenth Modification)

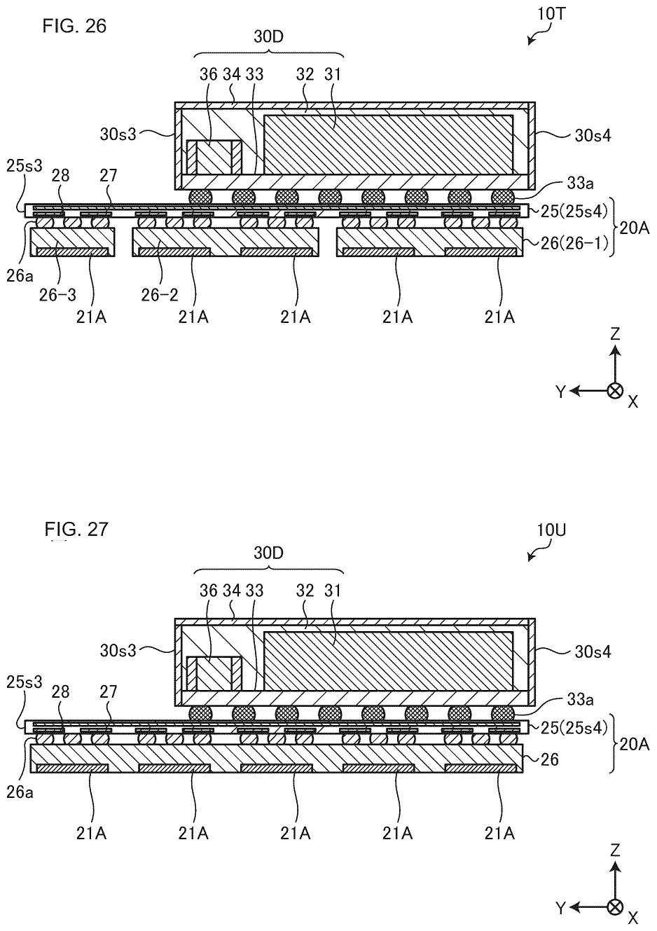

FIG. 26 is a sectional view of an antenna module according to a fourteenth modification taken along the Y direction. As illustrated in FIG. 26, the antenna module 10T according to the fourteenth modification differs in configuration from the above-described seventh embodiment in that three second antenna substrates 26-1, 26-2, and 26-3 are arranged along the Y direction. Two radiation electrodes 21A are arranged along the Y direction on each of the second antenna substrates 26-1 and 26-2. One radiation electrode 21A is provided on the second antenna substrate 26-3.

### (Fifteenth Modification)

FIG. 27 is a sectional view of an antenna module according to a fifteenth modification taken along the Y direction. As illustrated in FIG. 27, the antenna module 10U according to the fifteenth modification differs in configuration from the above-described seventh embodiment in that one second antenna substrate 26 is provided. More specifically, in the fifteenth modification, one second antenna substrate 26 is connected to the other principal surface of one first antenna substrate 25. The radiation electrodes 21A are arranged along the Y direction on the second antenna substrate 26.

As is clear from the fourteenth and fifteenth modifications, the number of second antenna substrates 26 connected to the first antenna substrate 25 and the number of radiation electrodes 21A provided on the second antenna substrates 26 may be changed as appropriate in accordance with the required characteristics of the antenna module. The number of second antenna substrates 26 connected to a single first antenna substrate 25 may be, for example, two, four, six, or more. The total number of radiation electrodes 21A may be four or less, or six or more.

### (Sixteenth Modification)

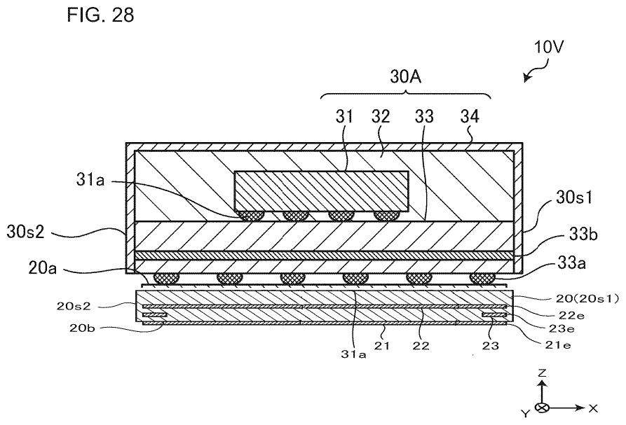

FIG. 28 is a sectional view of an antenna module according to a sixteenth modification. As illustrated in FIG. 28, the antenna module 10V according to the sixteenth modification differs in configuration from those of the above-described embodiments and modifications in that both the first substrate side surface 20s1 and the second substrate side surface 20s2 of the antenna substrate 20 are located inward from the first side surface 30s1 and the second side surface 30s2, respectively, of the radio-frequency circuit module 30A in plan view. In other words, both sides corresponding to the long sides (e.g., edges) of the antenna substrate 20 are located inside the edges of the radio-frequency circuit module 30A, such that the radio-frequency circuit module 30A extends beyond (e.g., overhangs) the antenna substrate 20 in the X direction on both sides of the antenna substrate 20. For example, referring to FIG. 28, the radio-frequency circuit module 30A may be centered over the antenna substrate 20 in the X direction. Accordingly, the dimensional accuracy of the antenna module 10V in which the radio-frequency circuit module 30A is mounted may be increased.

Further, as illustrated in FIG. 28, the end surfaces 21e of the radiation electrodes 21, the end surfaces 22e of the ground electrode 22, and the end surfaces 23e of the wiring lines 23 are not exposed at the substrate side surfaces of the antenna substrate 20, such that the end surfaces 21e of the radiation electrodes 21, the end surfaces 22e of the ground electrode 22, and the end surfaces 23e of the wiring lines 23 are covered by (e.g., are within) the dielectric layers of the antenna substrate 20. In other words, the end surfaces 21e of the radiation electrodes 21, the end surfaces 22e of the ground electrode 22, and the end surfaces 23e of the wiring lines 23 are spaced apart from the substrate side surfaces of the antenna substrate 20 toward the center of the antenna substrate 20. This may enhance the strength between substrate layers by preventing oxidation.

Note that the above-described embodiments are intended to facilitate understanding of the present disclosure and are not intended to limit the interpretation of the present disclosure. The present disclosure can be altered or modified without departing from the spirit thereof, and the present disclosure includes equivalents thereof.

The present disclosure may have the following configurations.

(1) An antenna module including:
an antenna substrate on which at least one radiation electrode is provided; and
a radio-frequency circuit module mounted on the antenna substrate,
wherein the radio-frequency circuit module has a rectangular shape with two long sides and two short sides in a plan view and has a first side surface, a second side surface, a third side surface, and a fourth side surface, the first side surface and the second side surface corresponding to the two long sides, the third side surface and the fourth side surface corresponding to the two short sides,
wherein the antenna substrate has a first substrate side surface, a second substrate side surface opposite to the first substrate side surface, a third substrate side surface, and a fourth substrate side surface, the third substrate side surface and the fourth substrate side surface being disposed between the first substrate side surface and the second substrate side surface,
wherein, in the plan view, the first substrate side surface of the antenna substrate is coplanar with the first side surface of the radio-frequency circuit module or overlaps the radio-frequency circuit module to be located inward from the first side surface, and
wherein, in the plan view, at least one of the second substrate side surface, the third substrate side surface, and the fourth substrate side surface of the antenna substrate is in a region that does not overlap the radio-frequency circuit module.

(2) The antenna module according to (1),
wherein the radio-frequency circuit module includes
   a circuit board,
   a radio-frequency circuit including an RFIC and provided on the circuit board,
   a mold resin that covers the radio-frequency circuit, and
   a shield that covers an upper surface and a side surface of the mold resin.

(3) The antenna module according to (1),
wherein the radio-frequency circuit module includes
   a radio-frequency circuit including an RFIC,
   a mold resin that covers the radio-frequency circuit, and
   a shield that covers an upper surface and a side surface of the mold resin.

(4) The antenna module according to (2) or (3),
wherein the radio-frequency circuit further includes at least one of an IC different from the RFIC and a chip component.

(5) The antenna module according to any one of (1) to (4),
wherein the antenna substrate includes an antenna element different from the radiation electrode, and
wherein the antenna element has a radiation pattern with a directivity in a direction parallel to a surface of the antenna substrate.

(6) The antenna module according to any one of (1) to (5),
wherein the antenna substrate includes an electrode on at least one of a surface layer and an inner layer of the antenna substrate, and
wherein the electrode provided on the at least one of the surface layer and the inner layer is exposed at a substrate side surface of the antenna substrate.

(7) The antenna module according to any one of (1) to (6),
wherein the antenna substrate includes a ground electrode provided on an inner layer of the antenna substrate, and
wherein the ground electrode is exposed at a substrate side surface of the antenna substrate.

(8) The antenna module according to any one of (1) to (7),
wherein an end surface of the radiation electrode provided on the antenna substrate is coplanar with a substrate side surface of the antenna substrate.

(9) The antenna module according to (7),
wherein the antenna substrate includes a wiring line provided on an inner layer of the antenna substrate and connected to the ground electrode, and
wherein the wiring line is exposed at a substrate side surface of the antenna substrate.

(10) The antenna module according to any one of (1) to (5),
wherein the antenna substrate includes electrodes on a surface layer and an inner layer of the antenna substrate, and
wherein each of the electrodes provided on the surface layer and the inner layer is located inward from a substrate side surface of the antenna substrate.

(11) The antenna module according to any one of (1) to (10),
wherein, in the plan view, the first substrate side surface and the second substrate side surface of the antenna substrate are coplanar with the first side surface and the second side surface, respectively, of the radio-frequency circuit module, or are located inward from the first side surface and the second side surface, respectively.

(12) The antenna module according to any one of (1) to (11), further including:
a resin layer provided between the antenna substrate and the radio-frequency circuit module.

(13) The antenna module according to (12),
wherein the resin layer fills a gap between the antenna substrate and the radio-frequency circuit module and covers a substrate side surface of the antenna substrate.

(14) The antenna module according to any one of (1) to (12), further including:
an insulating layer provided on a substrate side surface of the antenna substrate and made of a material different from a material of the antenna substrate.

(15) The antenna module according to (6), further including:
a plating layer that covers the electrode exposed at the substrate side surface of the antenna substrate.

(16) The antenna module according to any one of (1) to (15),
wherein the first substrate side surface and the second substrate side surface of the antenna substrate are inclined in a tapered manner.

(17) A method for manufacturing an antenna module,
wherein the antenna module includes
an antenna substrate on which at least one radiation electrode is provided and that has a first substrate side surface, a second substrate side surface opposite to the first substrate side surface, a third substrate side surface, and a fourth substrate side surface, the third substrate side surface and the fourth substrate side surface being disposed between the first substrate side surface and the second substrate side surface, and
a radio-frequency circuit module that is mounted on the antenna substrate and that has a rectangular shape with two long sides and two short sides in plan view,
wherein the method includes:
cutting the antenna substrate along the first substrate side surface; and
mounting the radio-frequency circuit module on the antenna substrate such that, in plan view, the first substrate side surface of the antenna substrate after being cut is coplanar with a first side surface of the radio-frequency circuit module or overlaps the radio-frequency circuit module to be located inward from the first side surface, the first side surface corresponding to one of the long sides.

(18) The method for manufacturing the antenna module according to (17), further including:
cutting the antenna substrate on which the radio-frequency circuit module is mounted along at least one of the second substrate side surface, the third substrate side surface, and the fourth substrate side surface.

(19) The antenna module according to (1),
wherein the antenna substrate includes
   a first antenna substrate on which the radio-frequency circuit module is mounted, and
   a second antenna substrate on which the radiation electrode is provided, and
wherein the first antenna substrate has the first substrate side surface, the second substrate side surface, the third substrate side surface, and the fourth substrate side surface.

(20) The antenna module according to (19),
wherein the second antenna substrate includes a plurality of second antenna substrates connected to the first antenna substrate, and
wherein the at least one radiation electrode is provided on each of the plurality of second antenna substrates.

### REFERENCE SIGNS LIST

10, 10A, 10B, 10C, 10D, 10E, 10F, 10G, 10H, 10I, 10J, 10K, 10L, 10M, 10N, 10O, 10P, 10Q, 10R, 10S, 10T, 10U, 10V antenna module
20, 20A antenna substrate
20a first principal surface
20b second principal surface
20s1, 25s1 first substrate side surface
20s2, 25s2 second substrate side surface
20s3, 25s3 third substrate side surface
20s4, 25s4 fourth substrate side surface
21, 21A radiation electrode
21e, 22e, 23e end surface
22 ground electrode
23 wiring line
24 via
25 first antenna substrate
26 second antenna substrate
30, 30A, 30B, 30C, 30D radio-frequency circuit module
30s1 first side surface
30s2 second side surface
30s3 third side surface
30s4 fourth side surface
31 RFIC
32 mold resin
33 circuit board
34 shield
35 power supply IC
36 chip component
40 connector
41 antenna element
50, 50A resin layer
51 insulating layer
52 plating layer

1. An antenna module, comprising:
an antenna substrate;
at least one radiation electrode on the antenna substrate; and
a radio-frequency circuit module on the antenna substrate,
wherein the radio-frequency circuit module has a rectangular shape with two long sides and two short sides in a plan view, the rectangular shape having a first side surface, a second side surface, a third side surface, and a fourth side surface, the first side surface and the second side surface corresponding to the two long sides, and the third side surface and the fourth side surface corresponding to the two short sides,
wherein the antenna substrate has a first substrate side surface, a second substrate side surface opposite to the first substrate side surface, a third substrate side surface, and a fourth substrate side surface, the third substrate side surface and the fourth substrate side surface being disposed between the first substrate side surface and the second substrate side surface,
wherein, in the plan view, the first substrate side surface of the antenna substrate is coplanar with the first side surface of the radio-frequency circuit module or overlaps the radio-frequency circuit module to be located inward from the first side surface, and
wherein, in the plan view, at least one of the second substrate side surface, the third substrate side surface, and the fourth substrate side surface of the antenna substrate is in a region that does not overlap the radio-frequency circuit module.

2. The antenna module according to claim 1, wherein the radio-frequency circuit module includes:
a circuit board;
a radio-frequency circuit including an RFIC on the circuit board;
a mold resin that covers the radio-frequency circuit; and
a shield that covers an upper surface and a side surface of the mold resin.

3. The antenna module according to claim 1, wherein the radio-frequency circuit module includes:
a radio-frequency circuit including an RFIC;
a mold resin that covers the radio-frequency circuit; and
a shield that covers an upper surface and a side surface of the mold resin.

4. The antenna module according to claim 3, wherein the radio-frequency circuit further includes at least one of an IC different from the RFIC and a chip component.

5. The antenna module according to claim 1, wherein:
the antenna substrate includes an antenna element different from the at least one radiation electrode, and
the antenna element has a radiation pattern with a directivity in a direction parallel to a surface of the antenna substrate.

6. The antenna module according to claim 1, wherein:
the antenna substrate includes an electrode on at least one of a surface layer and an inner layer of the antenna substrate, and
the electrode on the at least one of the surface layer and the inner layer is exposed at a substrate side surface of the antenna substrate.

7. The antenna module according to claim 6, further comprising a plating layer that covers the electrode exposed at the substrate side surface of the antenna substrate.

8. The antenna module according to claim 1, wherein:
the antenna substrate includes a ground electrode on an inner layer of the antenna substrate, and
the ground electrode is exposed at a substrate side surface of the antenna substrate.

9. The antenna module according to claim 8, wherein:
the antenna substrate includes a wiring line on an inner layer of the antenna substrate and connected to the ground electrode, and
the wiring line is exposed at a substrate side surface of the antenna substrate.

10. The antenna module according to claim 1, wherein an end surface of the at least one radiation electrode on the antenna substrate is coplanar with a substrate side surface of the antenna substrate.

11. The antenna module according to claim 1, wherein:
the antenna substrate includes electrodes on a surface layer and an inner layer of the antenna substrate, and
each of the electrodes on the surface layer and the inner layer is located inward from a substrate side surface of the antenna substrate.

12. The antenna module according to claim 1, wherein, in the plan view, the first substrate side surface and the second substrate side surface of the antenna substrate are coplanar with the first side surface and the second side surface, respectively, of the radio-frequency circuit module, or are located inward from the first side surface and the second side surface, respectively.

13. The antenna module according to claim 1, further comprising a resin layer between the antenna substrate and the radio-frequency circuit module.

14. The antenna module according to claim 13, wherein the resin layer fills a gap between the antenna substrate and the radio-frequency circuit module and covers a substrate side surface of the antenna substrate.

15. The antenna module according to claim 1, further comprising an insulating layer on a substrate side surface of the antenna substrate and made of a material different from a material of the antenna substrate.

16. The antenna module according to claim 1, wherein the first substrate side surface and the second substrate side surface of the antenna substrate are inclined in a tapered manner.

17. The antenna module according to claim 1, wherein the antenna substrate includes:
a first antenna substrate, the first antenna substrate having the first substrate side surface, the second substrate side surface, the third substrate side surface, and the fourth substrate side surface, and the radio-frequency circuit module being on the first antenna substrate; and
a second antenna substrate, the at least one radiation electrode being on the second antenna substrate.

18. The antenna module according to claim 17, wherein:
the second antenna substrate includes a plurality of second antenna substrates connected to the first antenna substrate, and
the at least one radiation electrode is on each of the plurality of second antenna substrates.

19. A method for manufacturing an antenna module, the method comprising:
providing an antenna substrate that has a first substrate side surface, a second substrate side surface opposite to the first substrate side surface, a third substrate side surface, and a fourth substrate side surface, the third substrate side surface and the fourth substrate side surface being disposed between the first substrate side surface and the second substrate side surface;
providing a radio-frequency circuit module that has a rectangular shape with two long sides and two short sides in plan view;
cutting the antenna substrate along the first substrate side surface; and
mounting a radio-frequency circuit module on the antenna substrate such that, in plan view, the first substrate side surface of the antenna substrate, after being cut, is coplanar with a first side surface of the radio-frequency circuit module or overlaps the radio-frequency circuit module to be located inward from the first side surface, the first side surface of the radio-frequency circuit module corresponding to one of the long sides.

20. The method for manufacturing the antenna module according to claim 19, further comprising cutting the antenna substrate, on which the radio-frequency circuit module is mounted, along at least one of the second substrate side surface, the third substrate side surface, and the fourth substrate side surface.
